(19) United States
(12) Patent Application Publication
(10) Pub. No.: US 2026/0281964 A1
(43) Pub. Date: Sep. 17, 2026

(54) METHOD FOR RECEIVING CORRECTION INFORMATION BY AUTOMATICALLY SELECTING REFERENCE STATION THAT IS MOST ADJACENT TO POSITION OF DEVICE

(71) Applicant: IUCF HYU (Industry University Cooperation Foundation Han yang University), Seoul (KR)

(72) Inventors: Sung-kwon Park, Seoul (KR); Chul Sun Park, Seoul (KR)

(73) Assignee: IUCF HYU (Industry University Cooperation Foundation Han yang University), Seoul (KR)

(21) Appl. No.: 19/103,489

(22) PCT Filed: Jul. 27, 2023
(86) PCT No.: PCT/KR2023/010933

§ 371 Date: Nov. 14, 2025

(30) Foreign Application Priority Data
Aug. 31, 2022 (KR) 10-2022-0109716

(51) Int. Cl. H04W 64/00

(52) U.S. Cl. CPC H04W 64/003

(57) ABSTRACT

A method for receiving correction information by automatically selecting a GNSS reference station that is most adjacent to the position of a device is disclosed. The method by which a device receives correction information, according to one embodiment, may comprise the steps of: selecting, on the basis of a GNSS reference station & mobile network base station mapping table generated by the device, a GNSS reference station that is most adjacent to the device; and receiving correction information generated by the selected most adjacent reference station.

### TECHNICAL FIELD

The following description relates to location positioning techniques.

### BACKGROUND ART

NTRIP is a service that transmits correction information generated in a GNSS reference station to a mobile station in real time through an internet network. In addition to internet network, correction information may be transmitted through a medium wave, a DMB broadcast, or the like, but there may be a region in which transmission is not possible, and thus an NTRIP service for transmitting correction information through internet network has been developed.

FIG. 1 is a diagram for describing an operation of transmitting correction information through the NTRIP service. Currently, the National Geographic Information Institute and seven other organizations (Korea Astronomical Research Institute, National Oceanographic Information Institute, Space Radio Center, National Meteorological Satellite Center, Korea Institute of Geoscience and Mineral Resources, Seoul Metropolitan Government, and Spatial Data Research Institute) operate a number of reference stations in Korea, and among them, the National Geographic Information Institute operates 63 reference stations.

The mobile station user receives the correction information of the GNSS reference station through the GNSS data integration center in order to perform precise location positioning calculation. To this end, the NTRIP Caster Host, Port, Mountpoint (GNSS reference station name, correction information reception format), latitude/longitude/altitude of the reference station, User-ID, Password, and the like should be known. When the correction information is received through the GNSS data integration center, the following information needs to be input. For example, correction information in the RTCM version 3.2 format such as 1) NTRIP Caster Host: gnssdata.or.kr, 2) Port: 2101, 3) Mountpoint: SOUL-RTCM32 (the most adjacent GNSS reference station name and correction information format to the mobile station position), 4)User ID/Password: user ID/gnss, and 5) GNSS reference station latitude/longitude/altitude may be received from the Seoul reference station.

In this way, in order to use the RTK service, the terminal performing the location positioning needs to select the most adjacent GNSS reference station to its own position and receive the correction information. In the moving mobile service using the RTK, since the position is changed from time to time, it is cumbersome to select the most adjacent GNSS reference station each time the position is changed.

### DETAILED DESCRIPTION OF THE INVENTION

### Technical Problem

In order for a mobile network base station user to have a cm-level positioning accuracy performance using the RTK technology, correction information needs to be received from the most adjacent GNSS reference station (within about 10 to 15 km). During positioning, when the mobile network network base station user is used in specific region or as fixed type, the user selects the GNSS reference station as fixed and receives the correction information. However, moving mobile network base station users will be used more than fixed mobile network base station users in future position-based services. With the current RTK system, the moving mobile network base station user continuously has the inconvenience of having to select the GNSS reference station that is the most adjacent each time the region changes.

In the embodiment, a method is proposed in which a user may dynamically select the GNSS reference station that is the most adjacent and receive correction information without the need to manually set and select GNSS reference station information in the device (positioning terminal using RTK), and perform precise location positioning calculation in real time regardless of a change in a region.

In addition, a method of automatically selecting the GNSS reference station that is the most adjacent using a unique number (Cell-ID) of a mobile network base station to receive correction information may be provided.

### Technical Solution

A method by which a device receives correction information may include selecting, on the basis of a GNSS reference station & mobile network base station mapping table generated by the device, a GNSS reference station that is the most adjacent to the device; and receiving correction information generated by the selected most adjacent GNSS reference station.

The selecting may include automatically selecting the GNSS reference station that is the most adjacent using a unique number (Cell-ID) of a mobile network base station to which the device is connected.

The receiving correction information may include receiving the correction information generated by the selected most adjacent GNSS reference station through the NTRIP service using a mobile communication module.

The receiving correction information may include performing precise location positioning calculation using a satellite signal received from a GNSS satellite and the received correction information.

The base GNSS reference station & mobile network base station mapping table may be generated as a single group by grouping a GNSS reference station and multiple mobile network base stations installed within a certain range from the GNSS reference station based on the position information where the GNSS reference station is installed.

A device may include a GNSS reference station selecting unit configured to select, on the basis of a GNSS reference station & mobile network base station mapping table generated by the device, a GNSS reference station that is most adjacent to the device; and a correction information receiving unit configured to receive correction information generated by the selected most adjacent GNSS reference station.

A method by which a GNSS reference station sends correction information may include generating correction information according to being selected, on the basis of a GNSS reference station & mobile network base station mapping table generated by the device, as a GNSS reference station that is the most adjacent to the device; and sending the generated correction information to the device.

### Advantageous Effects

When the user uses the device (the positioning terminal using the RTK), it is not necessary to manually set and select the GNSS reference station information, and it is possible to dynamically select the GNSS reference station that is the most adjacent to receive the correction information and perform the precise location positioning calculation in real time regardless of the regional change. As a result, the user may dynamically receive the correction information without unnecessary processes such as finding the GNSS reference station that is the most adjacent and inputting related information during precise location positioning calculation.

The user may perform precise location positioning calculation without the need to manually find nearby GNSS reference station and input information, as the device automatically selects nearby GNSS reference station on its own.

### BRIEF DESCRIPTION OF THE DRAWINGS

FIG. 1 is a diagram for describing an operation of transmitting correction information through the NTRIP service.

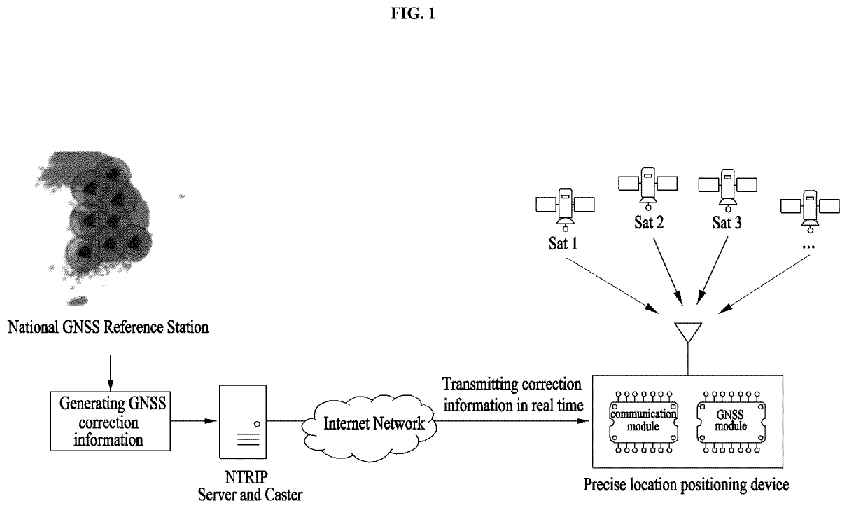

FIG. 2 is a diagram for describing the internal structure diagram of device, according to an embodiment.

FIG. 3 is a diagram for describing the GNSS reference station & mobile network base station mapping table, according to an embodiment.

FIG. 4 is a diagram for describing an operation of receiving correction information generated from a nearby GNSS reference station through the mobile network base station, according to an embodiment.

FIG. 5 is a diagram for describing an operation of performing precise location positioning calculation, according to an embodiment.

FIG. 6 is a diagram for describing an operation of receiving correction information according to position of the device, according to an embodiment.

FIG. 7 is a flowchart for describing a method for receiving correction information of the device, according to an embodiment.

FIG. 8 is a flowchart of a method for transmitting correction information of the GNSS reference station, according to an embodiment.

### BEST MODE FOR CARRYING OUT THE INVENTION

Hereinafter, embodiments will be described in detail with reference to the accompanying drawings.

The embodiment relates to automatic selection and reception of correction information required for relative positioning using a satellite navigation system, and an operation of automatically selecting the GNSS reference station that is the most adjacent using a unique number (Cell-ID) of the mobile network base station to receive correction information will be described. As a result, it is possible to dynamically receive the correction information generated from the GNSS reference station without unnecessary processes such as searching for the GNSS reference station that is the most adjacent from the device (e.g., a positioning terminal using RTK) and inputting related information.

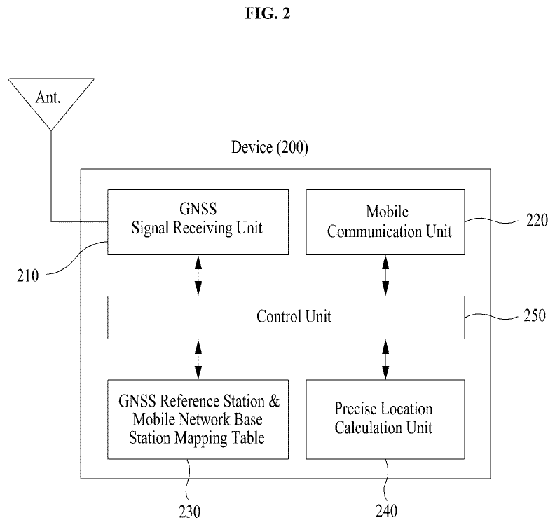

FIG. 2 is a diagram for describing the internal structure diagram of device, according to an embodiment.

The device 200 is for automatically selecting the GNSS reference station located at the most adjacent distance using the mobile network base station and receiving correction information, and may include, for example, a smartphone, a mobile phone, a navigation device, a computer, a notebook computer, a digital broadcasting terminal, a personal digital assistants (PDA), a portable multimedia player (PMP), a tablet PC, a wearable device, and the like.

Such device 200 is a positioning terminal/apparatus using RTK, for example, the RTK technology may be used in various forms in various fields such as smartphones, automobile internal GPS equipment, drone internal GPS equipment, golf GPS equipment, and the like.

The device 200 may refer to one of various physical computer apparatuses that may communicate with other electronic devices and/or a server through a network using a wireless communication or a wired communication manner.

The device 200 may include a GNSS signal receiving unit 210, a mobile communication unit 220, a GNSS reference station & mobile network base station mapping table 230, a precise position calculation unit 240, and a control unit 250.

The GNSS signal receiving unit 210 may receive a satellite signal from the GNSS satellite.

The mobile communication unit 220 may receive the correction information through the NTRIP service. The mobile communication unit 220 may receive correction information from the GNSS reference station that is the most adjacent through a mobile communication module (e.g., 6G, 5G, LTE, LTE-M, etc.).

The GNSS reference station & mobile network base station mapping table 230 may be one that is provided to select the GNSS reference station position that is the most adjacent to the current position of the device. The GNSS reference station & mobile network base station mapping table 230 may be generated as a single group by grouping a GNSS reference station and multiple mobile network base stations installed within a certain range from the GNSS reference station based on position information where the GNSS reference station is installed. This GNSS reference station & mobile network base station mapping table 230 may be updated in conjunction with an external server, such as the National Geographic Information Institute. For example, the GNSS reference station & mobile network base station mapping table 230 may be updated using an OTA scheme, a Bluetooth/NFC scheme, or the like.

The precise position calculation unit 240 may calculate a precise location position using the raw data and the correction information of the GNSS satellite.

The control unit 250 may perform control, management, and the like for each internal configuration.

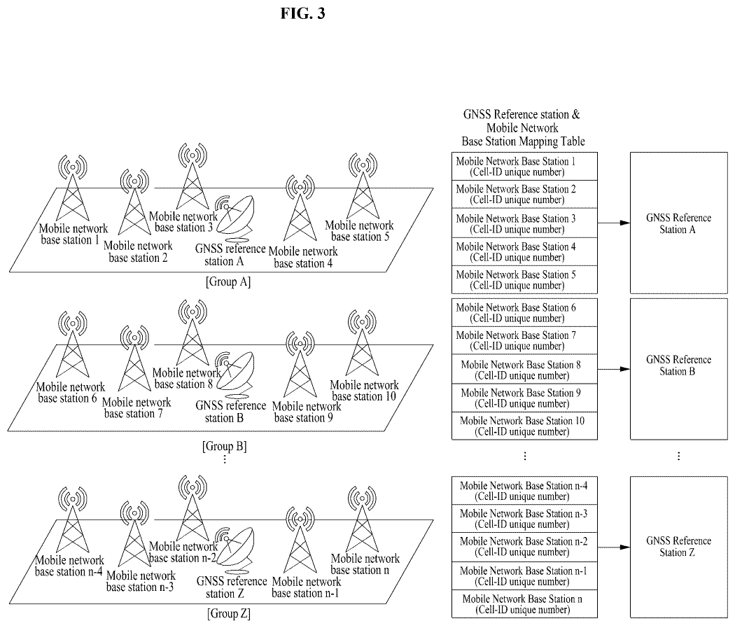

FIG. 3 is a diagram for describing the GNSS reference station & mobile network base station mapping table, according to an embodiment.

The device may automatically select the GNSS reference station that is the most adjacent using unique information (Cell-ID) of the connected mobile network base station. FIG. 3 illustrates a process of grouping mobile network base stations adjacent to a GNSS reference station. In advance, the GNSS reference station and the mobile network base station installed within a certain range (for example, within about 10 to 15 km) from position where the GNSS reference station is installed may be grouped in the device to form the mapping table. The GNSS reference station & mobile network base station mapping table may be generated by a terminal manufacturer in advance during terminal manufacturing. In this case, the size of the mapping table using the mobile network base station and the GNSS reference station may be changed according to the number of GNSS reference stations, the number of mobile network base stations adjacent to the GNSS reference station, or the like.

Each device stores information of the GNSS reference station & mobile network base station mapping table specified in FIG. 3. Each device may know the GNSS reference station information that is the most adjacent at the same time as being connected to the mobile network base station using the information in the stored GNSS reference station & mobile network base station mapping table, and may automatically connect to the NTRIP server and the caster.

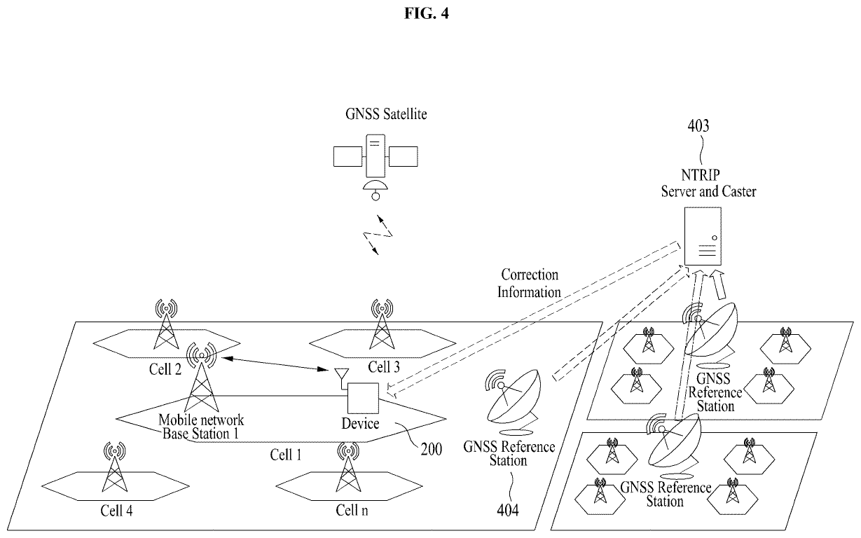

FIG. 4 is a diagram for describing an operation of receiving correction information generated from a nearby GNSS reference station through the mobile network base station, according to an embodiment.

The device 200 may automatically select the nearby mobile network base station using the mobile network base station during precise location positioning calculation in a specific cell and receive correction information. The device 200 may automatically select the GNSS reference station that is the most adjacent to the connected mobile network base station using the GNSS reference station & mobile network base station mapping table, and receive correction information generated in the selected GNSS reference station through the NTRIP service of the NTRIP server and caster 403.

In an example, when there are a plurality of GNSS reference stations that are the most adjacent, the device 200 may perform precise location positioning calculation using correction information received earlier. Alternatively, when there are a plurality of GNSS reference stations that are the most adjacent, the device 200 may perform precise location positioning calculation by receiving all of the plurality of correction information.

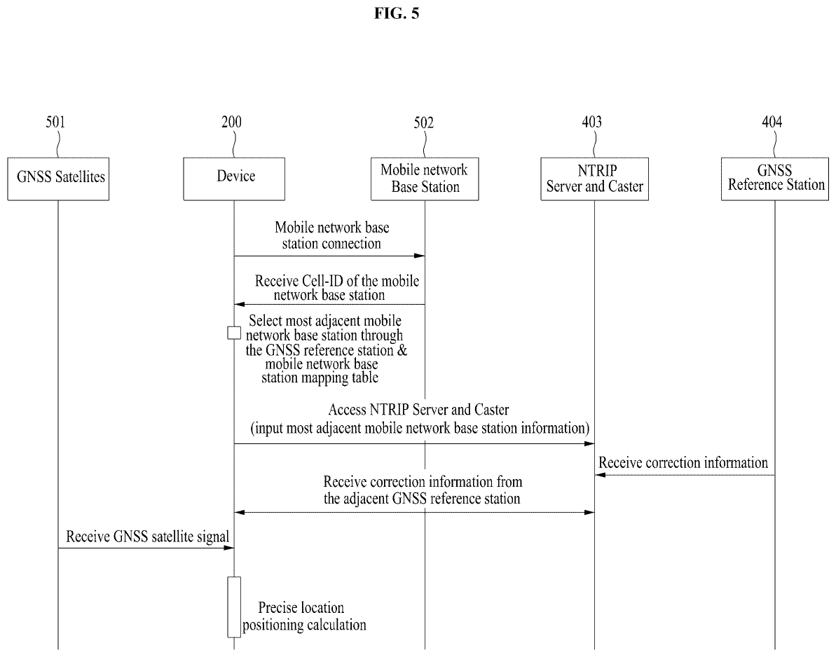

FIG. 5 is a diagram for describing an operation of performing precise location positioning calculation, according to an embodiment.

In FIG. 5, an operation of performing precise location positioning calculation through data transmission and reception between the GNSS satellites 501, the device 200, the mobile network base station 502, the NTRIP server and caster 403, and the GNSS reference station 404 will be described.

The device 200 may receive the unique number (Cell-ID) of the mobile network base station from the mobile network base station 502 by being connected to the mobile network base station 502 through mobile network base station connection.

The device 200 may select the GNSS reference station that is the most adjacent to device 200 through the GNSS reference station & mobile network base station mapping table. For example, the GNSS reference station that is the most adjacent to the device 200 may be selected through the GNSS reference station & mobile network base station mapping table based on position data of the device 200. Here, the GNSS reference station 404 shown in FIG. 5 means the GNSS reference station that is the most adjacent.

The device 200 may access NTRIP server and caster 403. The device 200 may input the selected most adjacent mobile network base station information through the GNSS reference station & mobile network base station mapping table. The NTRIP server and caster 403 may request the GNSS reference station 404 to generate correction information by using the mobile network base station information received from the device 200. The GNSS reference station 404 may deliver the generated correction information to the NTRIP server and caster 403. In other words, the NTRIP server and caster 403 may receive the generated correction information from the GNSS reference station 404.

The NTRIP server and caster 403 may deliver the correction information generated from the GNSS reference station 404 to the device 200. The device 200 may receive the generated correction information from the GNSS reference station 404 through the NTRIP service of the NTRIP server and caster 403.

The device 200 may receive satellite signals from GNSS satellites 501. The device 200 may perform precise location positioning calculation using the satellite signal received from the GNSS satellites 501 and correction information received from the GNSS reference station 404.

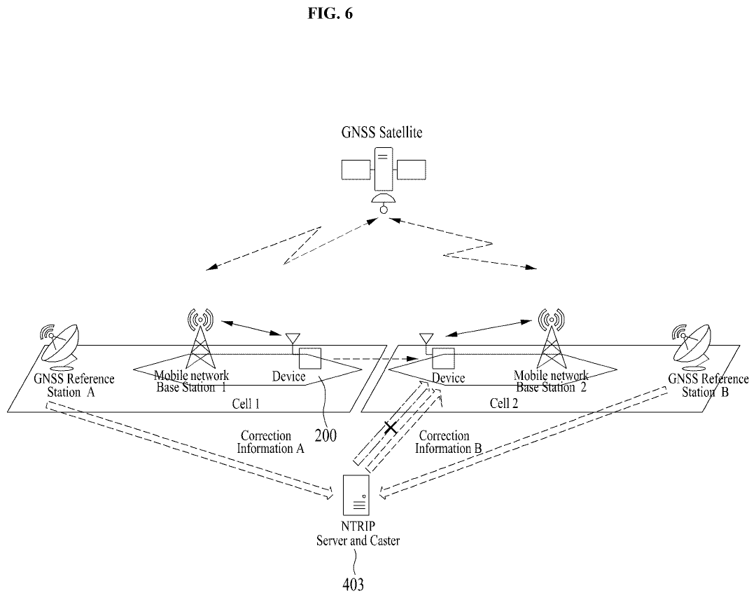

FIG. 6 is a diagram for describing an operation of receiving correction information according to position of the device, according to an embodiment.

When the device 200 is used as a moving type rather than a fixed type, the device 200 may receive correction information generated from a new mobile network base station existing at another position. When the position data of the moving type-based device 200 changes, the device 200 may receive the generated correction information from the GNSS reference station present at the conversion position. At this time, whether the position data of the device 200 is changed may be determined through the connection with the mobile network base station or the NTRIP server and caster 403.

For example, device 200 may be moved from cell 1 to cell 2. When the device 200 exists in the cell 1, the correction information of the GNSS reference station A is received, but the correction information of the GNSS reference station B may be received as it is moved to the cell 2. At this time, the NTRIP server and caster 403 may receive the correction information generated from the GNSS reference station B and deliver the correction information of the GNSS reference station B to the device 200 without delivering the correction information of a GNSS reference station A to the device 200 even when the correction information generated from the GNSS reference station A is received.

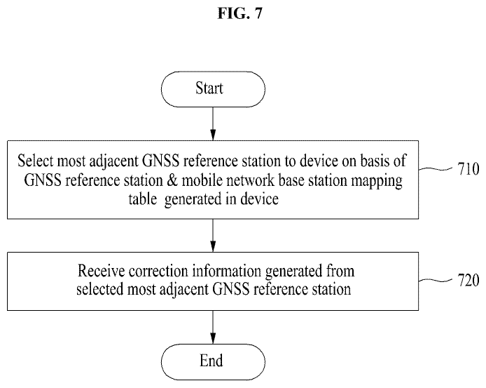

FIG. 7 is a flowchart for describing a method for receiving correction information of the device, according to an embodiment.

In step 710, the device may select the GNSS reference station that is the most adjacent to the device on the basis of a GNSS reference station & mobile network base station mapping table generated in the device. The device may determine the GNSS reference station position that is the most adjacent using the GNSS reference station & mobile network base station mapping table and select the determined GNSS reference station that is the most adjacent. In this case, the GNSS reference station & mobile network base station mapping table may be generated by grouping multiple mobile network base stations installed within a certain range (within about 10 to 15 km) from position where the GNSS reference station is installed in advance into one group. Accordingly, the device incorporates the GNSS reference station & mobile network base station mapping table. The device may receive the unique number from the mobile network base station through the connection with the mobile network base station, and automatically select the GNSS reference station that is the most adjacent through the GNSS reference station & mobile network base station mapping table.

In step 720, the device may receive the correction information generated from the selected GNSS reference station that is the most adjacent. The device may receive the generated correction information from the GNSS reference station that is the most adjacent through the mobile communication module. The device may perform precise location positioning calculation using the raw data of the GNSS satellite and the correction information received from the GNSS reference station that is the most adjacent.

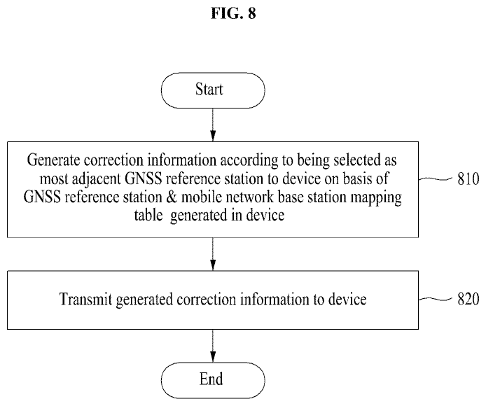

FIG. 8 is a flowchart of a method for transmitting correction information of the GNSS reference station, according to an embodiment.

In step 810, the GNSS reference station may generate correction information according to being selected as the GNSS reference station that is the most adjacent to the device on the basis of the GNSS reference station & mobile network base station mapping table generated in the device. For example, the GNSS reference station may be selected from one or a plurality of devices. The GNSS reference station may generate correction information for one or a plurality of devices.

In step 820, the GNSS reference station may transmit the generated correction information to the device. The GNSS reference station may deliver the correction information generated by the NTRIP server and the caster.

The technical effects of method for receiving correction information proposed in the embodiments will be described below.

In the future, the device used in the field of precise position services (positioning terminal using RTK) will be composed of components such as GNSS antennas, GNSS reception modules, communication modules (6G, 5G, LTE, LTE-M, NB-IoT, etc.), and MCUs. In the future, the device may directly receive the correction information or deliver the position information to the outside by mounting various communication modules. Therefore, the device may select the nearby GNSS reference station using the mobile network base station of the mounted communication module, and perform precise location positioning calculation.

As of 2022, the number of LTE mobile network base stations and the number of 5G mobile network base stations of the three telecommunication companies installed in the Republic of Korea are about 1 million and about 200,000, respectively. The number of mobile network base stations will be increased more than the current number because the three communication companies are planning to continuously install the mobile network base stations. In addition, the number of GNSS reference stations currently operated by the National Geographic Information Institute is about 87, which is a relatively small number compared to a mobile network base station.

According to an embodiment, the device may determine position of the GNSS reference station that is the most adjacent using the Cell-ID (unique number assigned to each base station) of the mobile network base station and receive correction information. The device groups multiple mobile network base stations installed at positions adjacent to the one GNSS reference station in advance and creates a mapping table based on this grouping. Through the tabulation, the GNSS reference station & mobile network base station mapping table may be formed, with multiple mobile network base stations mapped to a single GNSS reference station. When the device is connected to the nearby mobile network base station for communication during operation, the Cell-ID of the mobile network base station may be identified, and the position of the nearby GNSS reference station may be identified using the “GNSS reference station & mobile network base station mapping table”. As a result, the user of the device may perform precise location positioning calculation without the need to manually find nearby GNSS reference station and input information, as the device automatically selects nearby GNSS reference station on its own.

According to the embodiment, there is an effect that when a user performs precise location positioning calculation using a device, the user may automatically find the GNSS reference station that is the most adjacent to their current position and receive correction information without the need to find the nearby GNSS reference station and input information one by one, allowing the user to omit unnecessary processes and minimize the operations required for precise location positioning calculation.

### Description of Embodiments

The apparatus described above may be implemented in hardware components, software components, and/or combination of hardware components and software components. For example, the devices and components described in the embodiments may be implemented using one or more general-purpose or special-purpose computer, such as, for example, processor, controller, arithmetic logic unit (ALU), digital signal processor, microcomputer, field programmable gate array (FPGA), programmable logic unit (PLU), microprocessor, or any other device capable of executing and responding to instruction. The processing device may execute an operating system (OS) and one or more software applications executed on the operating system. Further, the processing device may also access, store, manipulate, process, and generate data in response to execution of the software. For ease of understanding, it may be described that one processing device is used, but a person skilled in the art may know that the processing device may include a plurality of processing elements and/or a plurality of types of processing elements. For example, the processing device may include a plurality of processors or one processor and one controller. Other processing configurations, such as parallel processors, are also possible.

The software may include a computer program, code, instruction, or combination of one or more of these, and may configure the processing device to operate as desired or may instruct the processing device independently or collectively. Software and/or data may be embodied in any type of machine, component, physical device, virtual equipment, computer storage medium, or device for interpretation by, or provision of instructions or data to, a processing device. The software may be distributed on a networked computer system, stored or executed in a distributed manner. The software and data may be stored in one or more computer readable recording media.

The method according to the embodiments may be implemented in the form of program instructions executable by various computer means and recorded on a computer readable medium. The computer-readable medium may include program instruction, data file, data structure, and the like, alone or in combination. The program instructions recorded on the medium may be those specially designed and configured for the embodiments or those known and usable by those skilled in the art of computer software. Examples of the computer-readable recording medium include magnetic media such as a hard disk, a floppy disk, and a magnetic tape, optical media such as a CD-ROM and a DVD, magneto-optical media such as a floptical disk, and hardware devices specially configured to store and perform program instruction such as a ROM, a RAM, and a flash memory. Examples of the program instruction include machine language codes such as those made by a compiler, as well as high-level language codes that may be executed by a computer using an interpreter or the like.

Although the embodiments have been described above with reference to the limited embodiments and the drawings, those skilled in the art may make various modifications and variations from the above description. For example, suitable results may be achieved if the described techniques are performed in an order different from method described, and/or if components of the described systems, structures, devices, circuits, etc., are combined or brought together in a form different from method described or are substituted or substituted for by other components or equivalents.

Therefore, other implementations, other embodiments, and equivalents of the claims are also within the scope of the following claims.

1. A method by which a device receives correction information, comprising:
selecting, on the basis of a GNSS reference station & mobile network base station mapping table generated by the device, a GNSS reference station that is the most adjacent to the device; and
receiving correction information generated by the selected most adjacent GNSS reference station.

2. The method of claim 1, wherein the selecting comprises:
automatically selecting the GNSS reference station that is the most adjacent using a unique number (Cell-ID) of a mobile network base station to which the device is connected.

3. The method of claim 1, wherein the receiving correction information comprises:
receiving the correction information generated by the selected most adjacent GNSS reference station through the NTRIP service using a mobile communication module.

4. The method of claim 3, wherein the receiving correction information comprises:
performing precise location positioning calculation using a satellite signal received from a GNSS satellite and the received correction information.

5. The method of claim 1, wherein the GNSS reference station & mobile network base station mapping table is generated as a single group by grouping a GNSS reference station and multiple mobile network base stations installed within a certain range from the GNSS reference station based on the position information where the GNSS reference station is installed.

6. A device comprising:
a GNSS reference station selecting unit configured to select, on the basis of a GNSS reference station & mobile network base station mapping table generated by the device, a GNSS reference station that is most adjacent to the device; and
a correction information receiving unit configured to receive correction information generated by the selected most adjacent GNSS reference station.

7. A method by which a GNSS reference station sends correction information, comprising:
generating correction information according to being selected, on the basis of a GNSS reference station & mobile network base station mapping table generated by the device, as a GNSS reference station that is the most adjacent to the device; and
sending the generated correction information to the device.
